(19) United States
(12) Patent Application Publication
(10) Pub. No.: US 2014/0074515 A1
(43) Pub. Date: Mar. 13, 2014

(54) Multi-Modal Sales Management Systems and Methods

(71) Applicant: Security Mutual Life Insurance Company of New York, Binghamton, NY (US)

(72) Inventors: Scott A. Sylvester, Endicott, NY (US); Oliver T. Hicks, Binghamton, NY (US)

(73) Assignee: Security Mutual Life Insurance Company of New York, Binghamton, NY (US)

(21) Appl. No.: 13/901,374

(22) Filed: May 23, 2013

Related U.S. Application Data
(60) Provisional application No. 61/699,671, filed on Sep. 11, 2012.

(51) Int. Cl. G06Q 30/06

(52) U.S. Cl. CPC G06Q 30/0635
USPC 705/4; 705/26.81; 705/7.18

(57) ABSTRACT

The present inventive subject matter is drawn to a system for managing sales of a set of products that require signatures from at least one party. In one aspect of the invention, the systems, configurations, and methods automatically detect, in an application, any signature that is required to complete the sales and is missing from the application and attempt to obtain signatures from the required signer(s) using different modalities. The different modalities include, but not limited to, e-mail, text messages, telephone call, etc. In some embodiments, the system is also configured to assign a human agent to retrieve the missing signature if the signature is not received within a predetermined amount of time.

This application claims the benefit of U.S. provisional application No. 61/699,671, filed Sep. 11, 2012. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is management of remote sales activities.

### BACKGROUND

The following description includes information that may be useful in understanding the present invention. It is not an admission that any of the information provided herein is prior art or relevant to the presently claimed invention, or that any publication specifically or implicitly referenced is prior art.

Many organizations, such as schools, insurance carriers, and credit card companies, have long been accepting applications electronically (i.e., receiving applications over the Internet). These organizations have developed software tools that allow customers or potential customers to conveniently provide personal information to the organizations. However, in addition to personal information, many of these applications also require one or more signatures from the customer and/or a third party (e.g., spouse, third party beneficiary, etc.) in order to complete the application process. To complicate things even more, in some industries, such as the insurance industry, empirical data has shown that the sale of a product will likely fall through if the application is not completed within a short period of time after the initial sales meeting. Thus, it is important, at least in some industries, to have all information and signatures required for an application or a sale request to be submitted within a short time frame.

When handwritten signatures are the only method to prove identity or intent, collection of signatures requires the signer to actively print a signature on a separate form and deliver the signed form to the organization. Subsequent systems were developed to accept not only handwritten signatures, but also electronic signatures (e.g., digital signatures), biometrics (e.g., fingerprint or retina), or voice signatures (i.e., using one person's unique voice characteristics for identification).

For example, U.S. Pat. No. 8,185,743 to Goott et al. titled “Systems and Methods for Application Locking Using an Internal and External Checksum”, filed Aug. 8, 2008, discloses an online insurance application submission system that allows the customer to provide electronic signature when the application is submitted over the Internet, or allows the customer to provide voice signature when the application is submitted over the phone.

Other efforts related to application management process includes:
Great Britain patent publication 2476054 to Ogden titled “Voice Authentication of Bill Payment Transactions”, filed Aug. 12, 2009; and
European patent publication EP 2466535 by de Andres titled “Method, System and Device for Managing and Optimising Shared Resources”, filed Mar. 12, 2010.

However, these systems do not integrate the mechanism for collecting signatures with the rest of the sales process. As such, there is still a need to improve on these to provide a better application management process.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY OF THE INVENTION

The present inventive subject matter is drawn to systems, configurations, and methods of managing sales of a set of products (e.g., an insurance policy) that require signatures from at least one party for an organization (e.g., an insurance agency, etc.). The set of products can comprise tangible products (e.g., furniture, books, etc.) and/or intangible products (e.g., data, services, insurance policies, leasing or renting a premise, etc.). In one aspect of the invention, the systems, configurations, and methods automatically (1) detect, in an application, any signature(s) that is required to complete the sales and is missing from the application and (2) attempt to obtain signatures from the required signer(s) using different modalities.

In some embodiments, the system comprises a database that stores information of potential customers. The information optionally comprising a sample signature of at least one potential customer. The system also includes a processor that is configured to receive a sale request via a first interface. The sale request misses at least one signature of the potential customer that is required in order to complete the sale. The processor is configured to automatically send a request for the missing signature via a second different interface. Upon receiving a signature in response to the request for the missing signature, the processor is configured to verify the received signature against the sample signature stored in the database.

In some embodiments, the sample signature can be a voice signature, a handwritten signature, a biometric signature or an electronic signature.

The processor is configured to send the request for missing signature in multiple different interfaces. For example, the processor can be configured to send the request for the missing signature via a telephonic interface, a computer network interface,

In some embodiments, the processor is further configured to automatically assign a sales agent to collect the missing signature when the missing signature is not received after the request has been sent via the different interfaces for a predetermined period of time.

In some embodiments, the processor is coupled with a calendaring system that stores schedules of a plurality of sales agent, wherein the processor is further configured to automatically assign the sales agent based on the workloads of the plurality of sales agents and urgency of the missing signature. The urgency of the missing signature can be a function of a time passed since the receipt of the sale order.

As mentioned above, the database is configured to store sample signatures. Thus, the processor of some embodiments is further configured to (i) receive via the first interface a signature of a different potential customer associated with the sale order and (ii) store the signature of the different potential customer as a sample signature in the database.

The sample signature can also be obtained during a different sale transaction with the potential customer.

In some embodiments, the processor is further configured to initiate an application withdrawal procedure when the missing signature is not received within a predetermined time period. The processor can also be configured to provide a reminder to the potential customer about the missing signature before the withdrawal procedure is initiated.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates an insurance management system of some embodiments.

FIG. 2 illustrates the different objects stored in the insurance data storage of some embodiments.

### DETAILED DESCRIPTION

It should be noted that any language directed to a computer should be read to include any suitable combination of computing devices, including servers, interfaces, systems, databases, agents, peers, engines, modules, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The present inventive subject matter is drawn to systems, configurations, and methods of managing sales of a set of products (e.g., an insurance policy) that require signatures from at least one party for an organization (e.g., an insurance agency, etc.). The set of products can comprise tangible products (e.g., furniture, books, etc.) and/or intangible products (e.g., data, services, insurance policies, leasing or renting a premise, etc.). In one aspect of the invention, the systems, configurations, and methods automatically (1) detect, in an application, any signature(s) that is required to complete the sales and is missing from the application and (2) attempt to obtain signatures from the required signer(s) using different modalities.

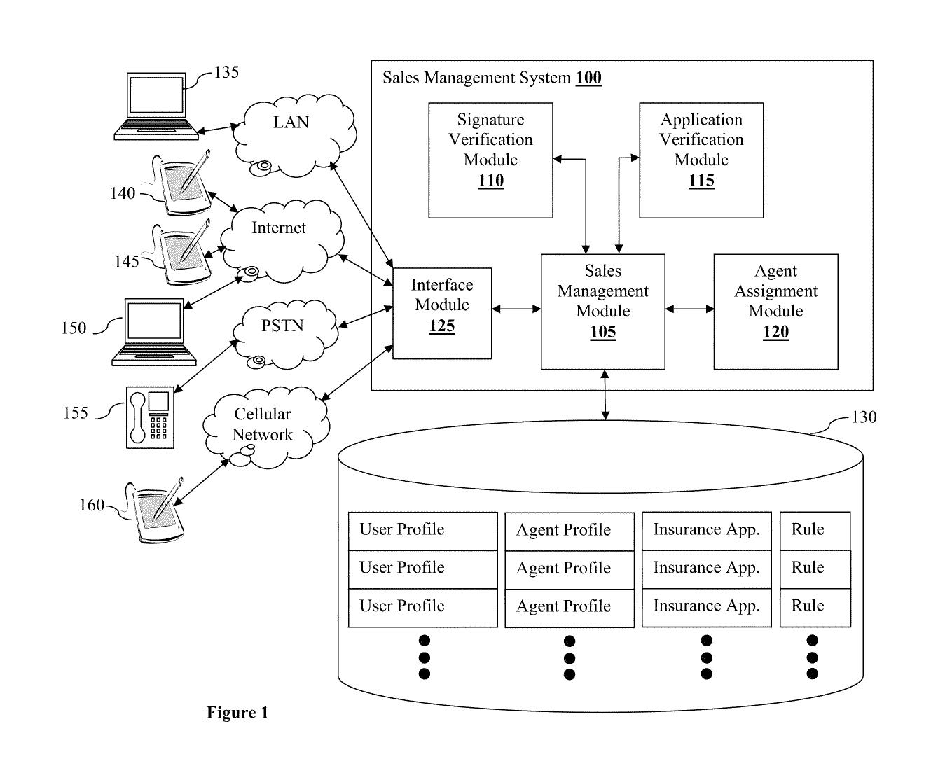

FIG. 1 conceptually illustrates an example of an insurance sales management system 100. The insurance sales management system 100 includes a sales management module 105, a signature verification module 110, an application verification module 115, an agent assignment module 120, and an interface module 125. In some embodiments, the sales management module 105, the signature verification module 110, the application verification module 115, the agent assignment module 120, and the interface module 125 are implemented as software programs that are executable in at least a processing unit (e.g., a microprocessor, etc.).

The interface module 125 of some embodiments includes multiple different interfaces for communicating with remote devices via different networks and protocols. For example, the interface module 125 can include an Ethernet interface for communicating with devices located in the same local area network as the insurance management system 100. The interface module 125 can also include an HTTP interface for communicating with remote devices over the Internet. The interface module 125 can also include a telephonic interface for communicating with telephones over a public switched telephone network, and mobile phones over a cellular network.

The sales management system 100 is also connected to an insurance data storage 130. In some embodiments, the insurance data storage 130 is an electrical storage that can comprise a file system, database management system, a document, a table, etc. The insurance data storage 130 of some embodiments is implemented in a non-transitory data storage such as a hard drive, a flash memory, etc. The insurance data storage 130 of some embodiments is configured to store information related to users (e.g., customers, potential customers, and people related to the customers such as spouses and third party beneficiaries, etc.), sales associates, sales request (e.g., insurance application). In some embodiments, the insurance data storage 130 also stores a set of rules on signature requirements for different sales requests.

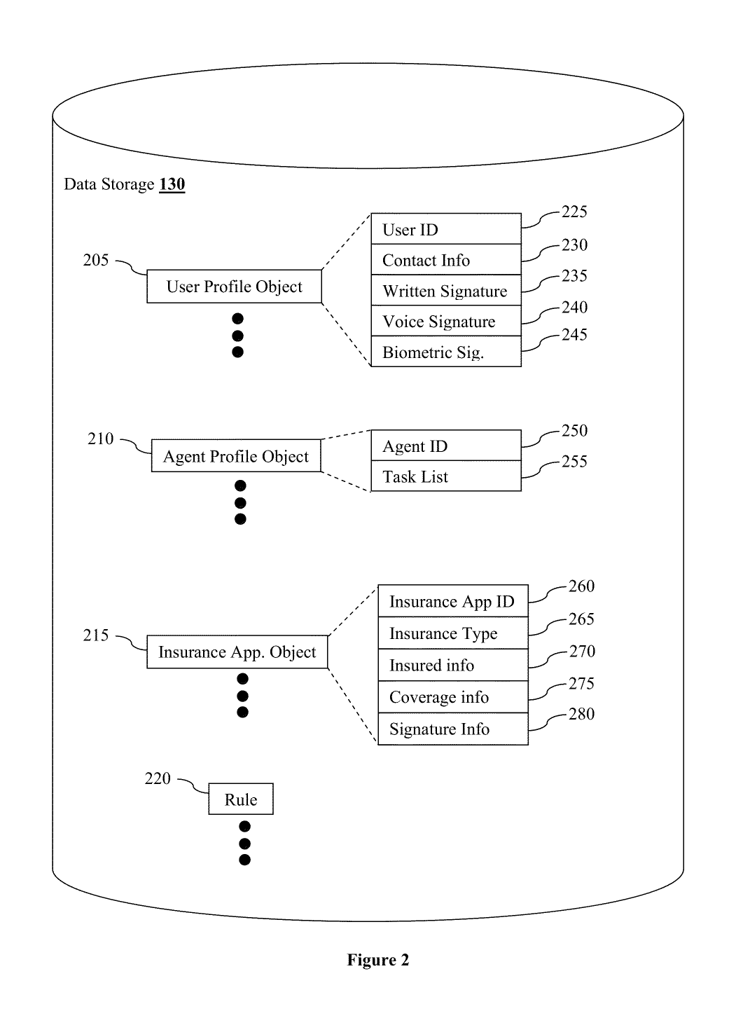

FIG. 2 illustrates the data being stored in the insurance data storage 130 in more detailed. Specifically, FIG. 2 shows that the insurance data storage 130 stores a set of user profile objects, a set of associate (agent) profile objects, and a set of sales request (e.g., insurance application) objects. Each of these objects is a self-contained and independently manageable object comprising a set of attributes. For example, a user profile object such as user profile object 205 can include a user identification attribute 225 for uniquely identifying the user associated with the user profile object 205, a contact information attribute 230 that includes one or more avenues (e.g., physical address, email address, phone number, fax number, etc.) for contacting the user, a written signature attribute 235 that stores information that allows the sales management system 100 to authenticate a written signature of the user (e.g., a written signature sample, etc.), a voice signature attribute 240 that stores information that allows the sales management system 100 to authenticate a voice signature of the user (e.g., a voice sample, etc.), and a biometric signature attribute 245 that stores information that allows the sales management system 100 to authenticate a biometric signature of the user (e.g., a biometric sample, etc.). Information related to the user's signatures or sample of the signatures can be obtained from the user during prior sales meeting or execution of a prior sales order.

A sales associate profile object, such as sales associate profile object 210, can include an associate identification attribute 250 for uniquely identifying the sales associate who is associated with the associate profile object 210, and a task list attribute 255 that stores all pending tasks of the sales associate.

A sales request object, such as insurance application object 215, can include an insurance application identification attribute 260 for uniquely identifying the insurance application associated with the object 215, an insurance type attribute 265 that indicates a type of insurance being applied for (e.g., a life insurance, an automobile insurance, a liability insurance , etc.), an insured information attribute 270 that stores information about the insured (e.g., name, age, gender, medical history, etc.), a coverage information attribute 275 that stores information about the insurance coverage being applied for (e.g., life insurance benefit, liability limit, etc.), and a signature information attribute 280 that all signatures that have been received in association with the insurance application.

Referring back to FIG. 1, the sales management system 100 can be communicatively coupled with different devices using different interfaces over different networks. For example, the sales management system 100 can be communicatively coupled with one or more computing devices (e.g., personal computer 135) over a network (e.g., a local area network, LAN, of the organization). The PC 135 can be used by internal sales associates to initiate and execute a sales of the products. The sales management system 100 can also be communicatively coupled with one or more portable computing devices 140 and 145 (e.g., laptop computers, tablet computers, smart phones, PDA, etc.) over a different network (e.g., the Internet). Portable devices 140 and 145 are carried by sales associates of the organization to remote locations for assisting the sales associates to conduct and execute remote sales of a set of products. In addition, the sales management system 100 can be communicatively coupled with a telephone, such as telephone 155, via the public switched telephone network (PSTN), and mobile device such as mobile device 160 over the cellular network.

The portable devices (140 and 145) of some embodiments allow the salespersons to initiate an application process with a customer during a sales meeting. For example, a software program is executed in each portable device that provides an interface to collect personal information of the customer. In some embodiments, the portable devices (140 and 145) also include (or are attached) to special input units (e.g., touch sensitive display, microphone, etc.) to collect signatures from the customers. Rightly equipped, the portable devices (140 and 145) can be configured to receive both electronic signature and voice signature from the customers.

In some embodiments, the sales management system 100 can provide an interface to PC 135 and portable devices 140 and 145 to provide product information to the sales associates and receive sales order information from the sales associates of the organization. In some embodiments, the sales management module 105 is configured to detect the connectivity through which the sales request is being received, and provide an interface to receive a signature based on the detected connectivity. In some embodiments, the types of interfaces include an audio interface and a touch-based input interface. For example, if the sales management module 105 detects that the sales order request is received through a telephonic connection, the sales management module 105 will provide an interface that is capable of receiving a voice signature from the associates or user. On the other hand, if it is detected that the sales order request is received through a web connection, the sales management module 105 will provide a web interface for retrieving a scanned copy of a written signature. In some embodiments, the sales management module 105 is also configured to detect one or more peripherals of the devices from which the sales order request is received, and provide an interface to receive a signature accordingly. For example, if it is detected that the device (e.g., the portable device 145) that sends the sales order request has a microphone, the sales management module 105 can provide an interface for receiving a voice signature in addition to an interface for receiving a written signature. When the sales associates receive a request to fulfill a sales order (e.g., purchase of an insurance policy) from a potential customer, the sales associates can send the request to the sales management system 100 through the interface module 125.

Other than the portable devices (140 and 145), the sales management module 105 is also configured to receive applications over the Internet. For example, the sales management module 105 of some embodiments includes a web server. The web server provides a graphical user interface through which customers may provide information to submit an application (or sales order request). The web server is also configured to receive different types of signatures (e.g., electronic signatures, voice signatures, handwritten signatures) if the computing devices of the customers are equipped to collect those signatures.

Furthermore, the sales management service of some embodiments also includes a telephonic interface to connect to telephones of the customers. In these embodiments, the sales management module 105 is also configured to receive applications over the phone. The sales management module 105 may also receive voice signatures from customers over the phone during the application process.

In some embodiments, the sales order request includes information related to the sales, and signature(s) that is required for the sales to be completed. Upon receiving a sales order request from the sales associate through the interface 125, the sales management module 105 instantiates a new insurance application object for the sales order request. The sales management module 105 also initializes the attributes of the insurance application object with information received in the sales order request, and generates a new identifier for the insurance application object. The sales management module 105 then stores the newly instantiated insurance application object in the data storage 130.

If a signature is included in the insurance application object, the sales management module 105 requests the signature verification module 110 to verify the authenticity of the signature. In some embodiments, the signature verification module 110 verifies the authenticity of the newly acquired signature by comparing the newly acquired signature against signature data stored in the insurance data storage 130.

As mentioned above, the insurance data storage 130 stores user profile objects that includes signature data of the user (e.g., written signature sample 235, voice signature sample 240, biometric signature sample 245, etc.). The signature data is often acquired by the sales management system 100 through previous interactions with the users. For example, when a user provided signatures when the user completed a previous sales order, the sales management module would extract the signature to form signature data, and store the signature data within the user profile object associated with the user.

Methods of comparing/verifying signatures to authenticate a user are well known to those who are skilled in the art and will not be discussed in detail here. The sales management module 105 would accept or reject the signature based on the authenticity of the newly acquired signature, as determined by the signature verification module 110. If the signature is determined to be authentic, the sales management module would keep the signature within the insurance application object and mark it as accepted. If the signature is determined not to be authentic, the sales management module 105 would discard the signature from the insurance application object.

The sales management module 105 then instructs the application verification module 115 to verify the completeness of the insurance application based on the insurance application object. First, the application verification module 115 retrieves the rules from the insurance data storage 130 and uses the rules to determine if signature(s) is required in order to complete the sales, and if so, whose signature(s) is needed. If one or more signature is missing from the insurance application object, the application verification module 115 would notify the sales management module 105 which signature(s) is still missing for the application.

When a signature from a user (e.g., an insured, a third party beneficiary, a spouse of the insured), the sales management module 105 retrieves the contact information of the user based on the user profile object associated with the user. As mentioned above, each user profile object can has a contact information attribute 230 that stores contact information of the user associated with the object. In some embodiments, the contact information includes methods of contacting the user using multiple different modalities (e.g., e-mail address, physical address, phone number, facsimile number, etc.). In some of these embodiments, the contact information attribute 230 also includes information that indicates which contact method is preferred. For example, a user can prefer to be communicated using email address over telephone.

Thus, the sales management module 105 of some embodiments is configured to automatically initiate a communication with the user through means and methods indicated in the user profile object associated with the user. In some embodiments, the sales management module 105 is configured to attempt to establish a communication with the user using first the more preferred methods, and only when the attempt fails the sales management module 105 would attempt to establish a communication with the user using the less preferred methods.

For example, if it is indicated that the user would prefer to be contacted using email over telephone, the sales management module 105 would instruct the interface to send an email message to the user over the Internet to request for the missing signature. Upon receiving the email, the user can reply with a scanned copy of the signature (or an electronic signature). When the sales management module 105 receives a signature from the interface 125, the sales management module 105 will use the signature verification module 110 to verify the authenticity of the signature, and use the application verification module 115 to determine the completeness of the application as described above.

It is contemplated that it is important to complete a sales order after an initial sales request is made, since sales are more likely to fall through if it is not completed immediately or shortly after the sales request. Thus, in the event that the sales management system 100 does not receive a response within a predetermined amount of time (e.g., 3 days, 5 days, etc.), the sales management module 105 is configured to use a different modality (i.e., a less preferred one) to contact the user. For example, after failing to receive an email response from the user, the sales management module 105 is configured to instruct the interface 125 to automatically place a phone call to the user through the public switched telephone network (PSTN). The interface 125 can generate pre-recorded or computer generated vocal instructions to ask the user for a voice signature. Once received the signature, the sales management module 105 can verify the signature the same way as described above.

In the event that the sales management system 100 has used all of the different modalities indicated in the user profile object to contact the user and still has not received a valid signature from the user (after the predetermined amount of time is passed), the sales management module 105 is configured to instruct the agent assignment module 120 to send a request to one of the sales associates to acquire the missing signature. In some embodiments, the agent assignment module 120 is configured to review each sales associate's task list from the agent profile object of the sales associate and assign an associate to be responsible for this task based on the associates' task lists. For example, the agent assignment module 120 can assign an associate who is determined to have the least amount of work. In other embodiments, the agent assignment module 120 can assign associate based on other factors as well (e.g., the associate's location relative to the user's physical address, the associate's schedules, urgency of the missing signature, etc.).

Once an associate is assigned, the sales management module 105 is configured to notify the associate using different modalities (e.g., e-mail of the associate, telephone number, etc.). The associate will be asked to obtain the missing signature of the application. The associate can visit the user at the user's physical address, call the user, e-mail the user, or use any other reasonable methods to obtain the user's signature. Once obtained, the associate would transmit the signature to the sales management system 100 through the interface 125. The sales management module 105 will then verify the signature and check the completeness of the application using the signature verification module 110 and application verification module 115 as described above.

In the event that the assigned sales associate is not able to obtain the signature within a predetermined amount of time (e.g., 7 days, 15 days, etc.), the sales management module 105 is configured to provide a last reminder to the purchaser of the product (or user) before initiating an application withdrawal procedure. For example, the sales management module 105 can notify the purchaser (e.g., by letter, e-mail, text, voice mail, etc.) in a manner that allows the purchaser to resolve the missing item. Such resolution can occur in any suitable manner, such as by clicking on a link or taking other actions. In some embodiments, the purchaser can resolve the missing item by giving voice authorization over the phone. If the missing item is still not resolved by a certain time after the notification is sent, or according to some other parameter(s), then the application can be withdrawn. The application withdrawal procedure can include marking the insurance application object as withdrawn and notifying the purchaser of the insurance product that the application is being withdrawn.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for executing a sale of a set of products that requires signatures from a plurality of potential customers, the system comprising:
a database storing information of potential customers, the information optionally comprising a sample signature of at least one potential customer;
a processor configured to:
receive a sale request via a first interface, the sale request missing at least one signature of the potential customer that is required in order to complete the sale;
automatically send a request for the missing signature via a second different interface; and
upon receiving a signature in response to the request for the missing signature, verifying the received signature against the sample signature stored in the database.

2. The system of claim 1, wherein the sample signature is a voice signature.

3. The system of claim 1, wherein the sample signature is a handwritten signature.

4. The system of claim 1, wherein the request for the missing signature is automatically sent via a telephonic interface.

5. The system of claim 1, wherein the request for the missing signature is automatically sent via a computer network interface.

6. The system of claim 1, wherein the processor is further configured to automatically assign a sales agent to collect the missing signature when the missing signature is not received after the request has been sent for a predetermined period of time.

7. The system of claim 6, wherein the processor is coupled with a calendaring system that stores schedules of a plurality of sales agent, wherein the processor is further configured to automatically assign the sales agent based on the workloads of the plurality of sales agents and urgency of the missing signature.

8. The system of claim 7, wherein the urgency of the missing signature is a function of a time passed since the receipt of the sale order.

9. The system of claim 1, wherein the processor is further configured to (i) receive via the first interface a signature of a different potential customer associated with the sale order and (ii) store the signature of the different potential customer as a sample signature in the database.

10. The system of claim 1, wherein the set of products comprises a group of insurance policies.

11. The system of claim 1, wherein the sample signature was obtained during a different sale transaction with the potential customer.

12. The system of claim 1, wherein the processor is further configured to initiate an application withdrawal procedure when the missing signature is not received within a predetermined time period.

13. The system of claim 12, wherein the processor is further configured to provide a reminder to the potential customer about the missing signature before the withdrawal procedure is initiated.

14. A system for executing a sale of a set of products that requires at least one signature of a potential customer at a point of sales, the system comprising:
a plurality of remote devices, wherein each remote device is coupled with a server via one of a plurality of type of connectivity and configured to (i) provide an interface to allow a potential customer to initiate a sales request of a set of products, and (ii) transmit the sales request to a server; and
the server coupled with the plurality of remote devices and configured to (i) receive the sales request from a remote device via one of the plurality of type of connectivity; (ii) detect a type of connectivity from the plurality of types of connectivity via which the sales request is received; and (iii) automatically instruct the remote device to offer a set of interfaces to receive a signature from the potential customer based on the detected type of connectivity.

15. The system of claim 14, wherein the set of interface comprises an audio interface.

16. The system of claim 14, wherein the set of interfaces comprises a touch-based input interface.

17. The system of claim 14, wherein the server is further configured to:
determine, upon receiving the sales request, that a second signature from a different potential customer is required in order to complete the sale; and
automatically send a request for the second signature.

18. The system of claim 17, wherein the server is further configured to automatically send the request for the second signature by assigning a sales agent to collect the second signature from the different potential customer.

19. The system of claim 17, wherein the server comprises a data storage that stores information of a plurality of potential customers.

20. The system of claim 19, wherein the information of each potential customer comprises a contact address of the potential customer.

21. The system of claim 20, wherein the server is further configured to automatically send the request for the second signature by retrieving a contact address of the different potential customer and sending the request for the second signature to the retrieved contact address.

22. The system of claim 21, wherein the contact address is an e-mail address, wherein the server is further configured to send the request for the second signature by sending an email to the retrieved e-mail address.
